(19) United States
(12) Patent Application Publication
(10) Pub. No.: US 2005/0051034 A1
(43) Pub. Date: Mar. 10, 2005

(54) Appliance for deep frying and slow cooking

(75) Inventor: Euphemia Lan Fan Cheng, Hong Kong (HK)

Correspondence Address: ALIX YALE & RISTAS LLP, 750 MAIN STREET, SUITE 1400, HARTFORD, CT, 06103, US

(73) Assignee: Highlander Enterprises Ltd.

(21) Appl. No.: 10/654,827

(22) Filed: Sep. 4, 2003

(51) Int. Cl. A23L 1/00

(52) U.S. Cl. 99/330

(57) ABSTRACT

A cooking appliance for both slow cooking and deep frying includes a deep frying vessel configured to support a removable ceramic slow cooking vessel therein and to transfer heat thereto in use. The appliance also includes a low-power thermostatically controlled heating element in heat-exchange relationship with the deep frying vessel, and a high-power thermostatically controlled heating element in heat-exchange relationship with the deep frying vessel. The appliance can be reconfigured to either deep fry or slow cook.

### BACKGROUND OF THE INVENTION

The present invention relates to an appliance for deep frying and slow cooking. More particularly, although not exclusively, the invention relates to an electrical appliance having reconfigurable vessels and a pair of heating elements selectively used for different types of cooking.

Electric deep fryers are known. These comprise a deep metallic pot or vessel and a high-power heating element controlled thermostatically. The heating element is usually situated at the base of the vessel.

Slow cookers are also known. These comprise a deep ceramic pot or vessel and a low-power heating element controlled thermostatically.

Small kitchens often have insufficient bench space to accommodate both a slow cooker and a deep fryer.

### OBJECT OF THE INVENTION

It is an object of the present invention to provide an appliance capable of both slow cooking and deep frying.

### DISCLOSURE OF THE INVENTION

There is disclosed herein is a cooking appliance comprising:
a deep frying vessel configured to support a removable ceramic slow cooking vessel therein and to transfer heat thereto in use,
a low-power thermostatically controlled heating element in heat-exchange relationship with the deep frying vessel, and
a high-power thermostatically controlled heating element in heat-exchange relationship with the deep frying vessel.

Preferably the low-power heating element surrounds the deep frying vessel.

Preferably the deep frying vessel has a base and the high-power heating element is at the base.

Preferably the appliance comprises individual thermostats controlling the low-power heating element and the high-power heating element respectively.

Preferably the appliance further comprises a casing within which the deep frying vessel is housed.

Preferably the appliance further comprises a control panel upon the casing for controlling the high-power heating element and the low-power heating element.

Preferably the ceramic slow cooking vessel is sized and shaped to be supported snugly within the deep frying vessel.

Preferably there is a see-through cover fitted upon the ceramic slow cooking vessel.

### BRIEF DESCRIPTION OF THE DRAWINGS

A preferred form of the present invention will now be described by way of example with reference to the accompanying drawings, wherein:

FIG. 1 is a schematic cross-sectional elevational view of a cooking appliance for both slow cooking and deep frying,

FIG. 2 is a schematic cross-sectional elevational view of the appliance of FIG. 1 in a slow cooking configuration,

FIG. 3 is a schematic cross-sectional elevational view of the appliance of FIG. 1 in a deep frying configuration,

FIG. 4 is a schematic plan view of the appliance of FIG. 1, and

FIG. 5 is a schematic circuit diagram for circuitry associated with the appliance of the preceding figures.

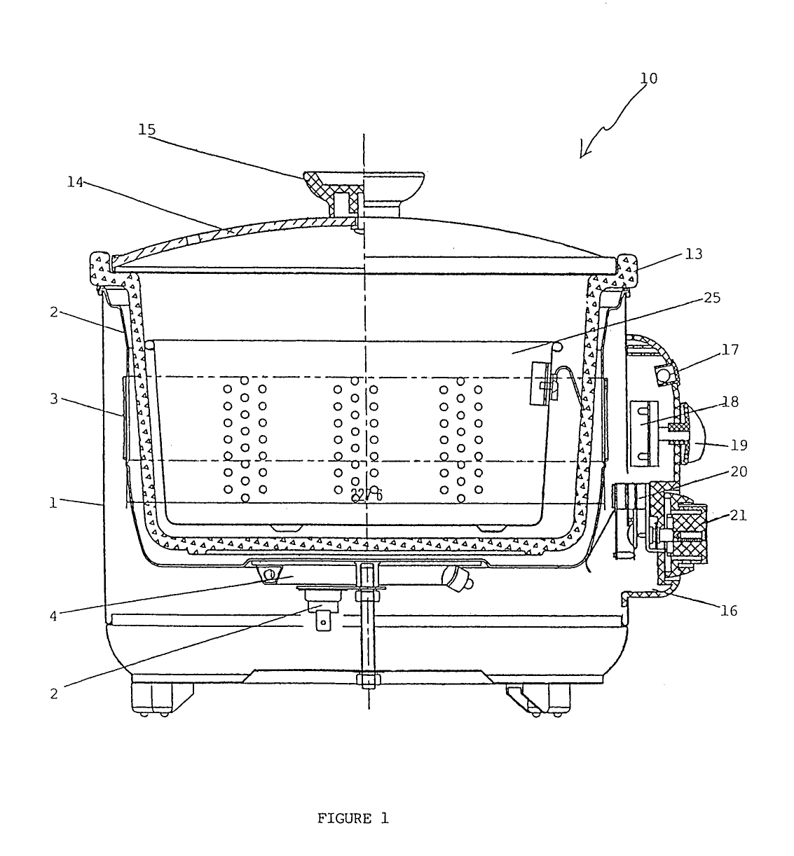

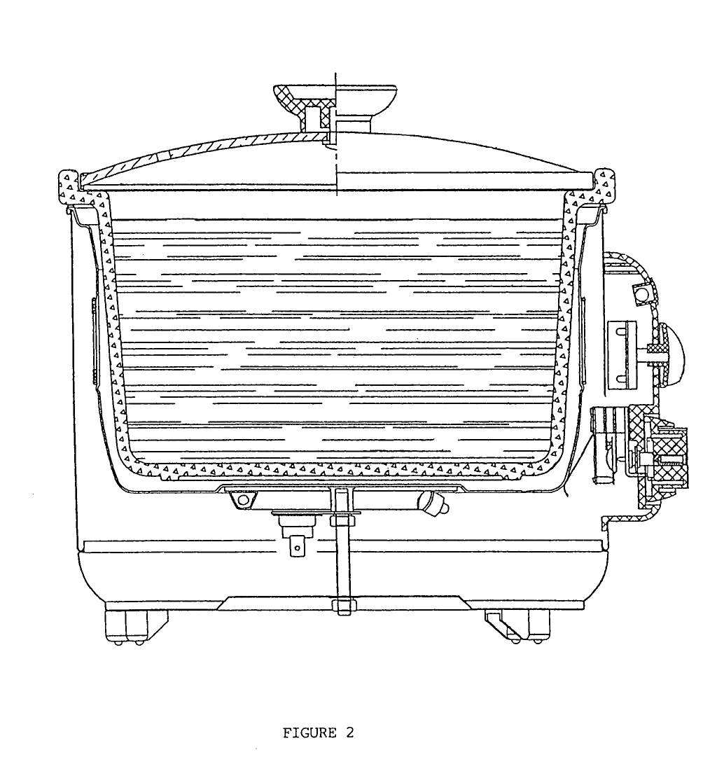

### DESCRIPTION OF THE PREFERRED EMBODIMENT

In the accompanying drawings there is depicted schematically a cooking appliance 10. The appliance 10 comprises a casing 11 typically made of moulded plastics material. Within the casing there is supported a deep frying vessel 12 made of metal such as aluminium or stainless-steel for example. Within the deep frying vessel 12 there is located a ceramic slow cooking vessel 13. There is a cover 14 made of glass or light-transmissive plastics for example and having a handle 15.

Mounted upon the casing 11 is a control panel 16 having a lamp 17, a functional switch 18 for operating the slow cooker, a control knob 19, a deep fryer thermostat 20 and a deep fryer thermostat control knob 21.

Surrounding the deep fryer vessel 12 is an electric slow cooker low-power heating element 23, typically of a 70 Watt rating. At the base of the deep fryer vessel 12 there is a high-temperature deep frying heating element 24, typically of a 180 Watt rating. There is a slow cooker thermostat 22 situated near the high-power heating element for positional convenience (this thermostat is not functionally associated with the high-power deep fryer heater 24).

Circuitry associated with the control panel 16, the above-described thermostats and the low-power and high-power heating elements is depicted in FIG. 5 and will not be described in detail.

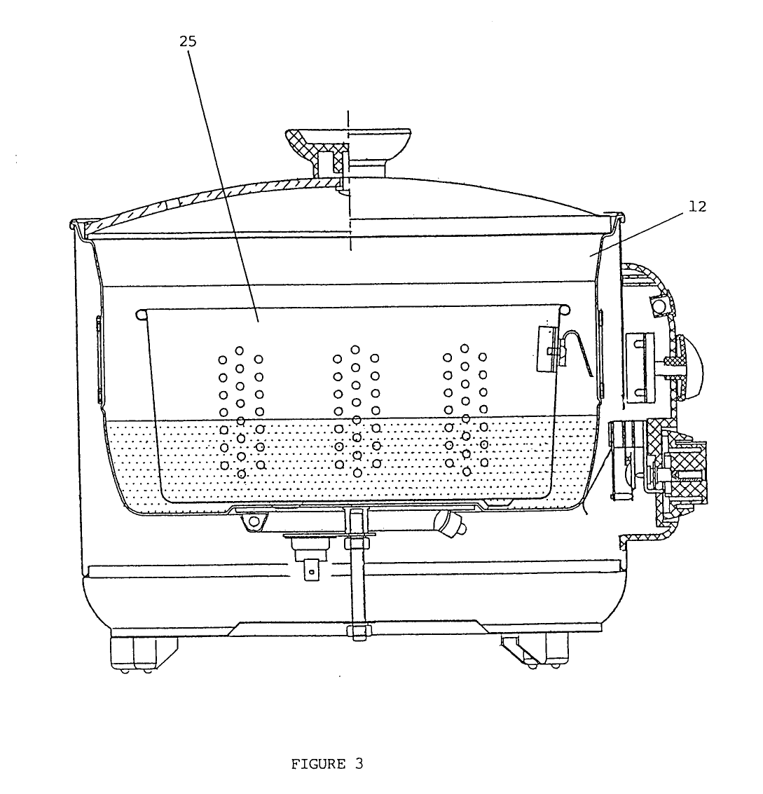

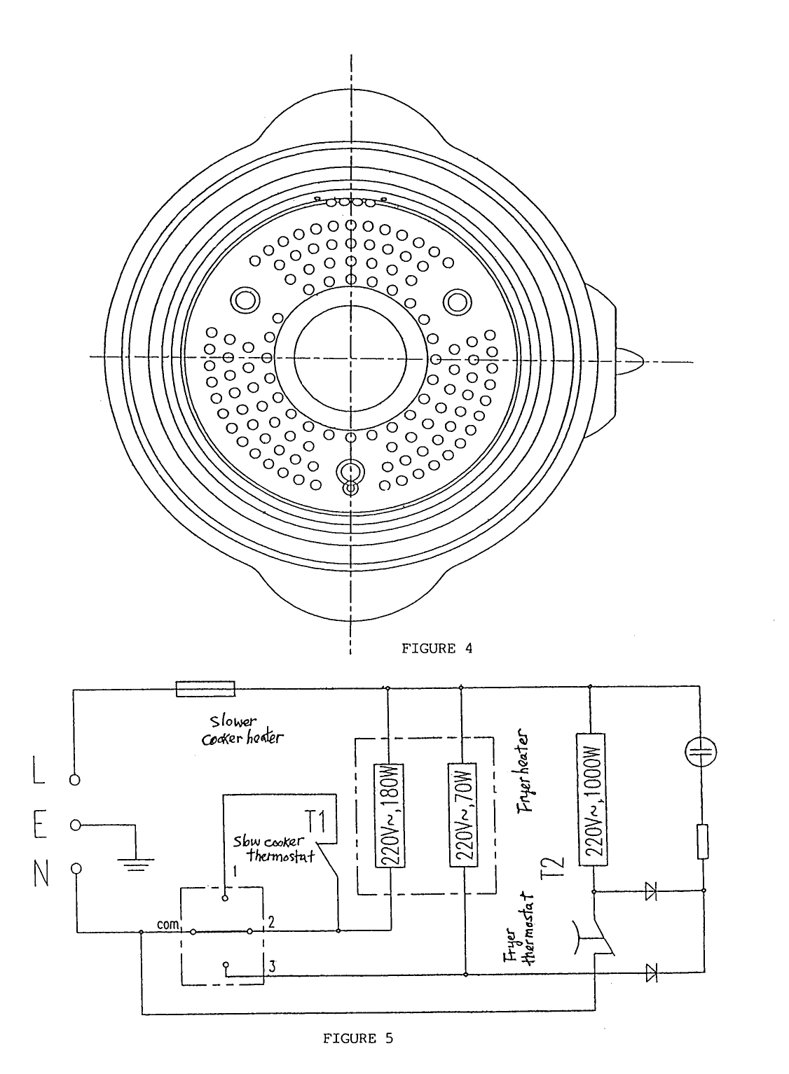

There is a perforated deep frying basket 25 that can be installed within the deep frying vessel 12 as depicted in FIG. 3—in which configuration the ceramic vessel 13 is removed.

In use of the appliance as a slow cooker with the deep frying basket removed from the ceramic vessel, one can broil food over an extended period by appropriate manipulation of the functional control knob 19. In this case, the low power heater 23 in conjunction with the frying basket 25 can be at least partially immersed.

It should be appreciated that modifications and alterations obvious to those skilled in the art are not to be considered as beyond the scope of the present invention. For example, the position of the low-power heating element might be altered and a self-timer circuit might be added to the circuitry for setting the cooking time during for slow cooking.

1. A cooking appliance comprising:
a deep frying vessel configured to support a removable ceramic slow cooking vessel therein and to transfer heat thereto in use,
a low-power thermostatically controlled heating element in heat-exchange relationship with the deep frying vessel, and
a high-power thermostatically controlled heating element in heat-exchange relationship with the deep frying vessel.

2. The appliance of claim 1 wherein the low-power heating element surrounds the deep frying vessel.

3. The appliance of claim 1 wherein the deep frying vessel has a base and the high-power heating element is at the base.

4. The appliance of claim 1 comprising individual thermostats controlling the low-power heating element and the high-power heating element.

5. The appliance of claim 1 further comprising a casing within which the deep frying vessel is housed.

6. The appliance of claim 5 comprising a control panel upon the casing for controlling the high-power heating element and the low-power heating element.

7. In combination with the appliance of claim 1, a ceramic slow cooking vessel sized and shaped to be supported snugly within the deep frying vessel.

8. The combination of claim 5 further comprising a see-through cover fitted upon the ceramic slow cooking vessel.
